(19) United States
(12) Patent Application Publication
(10) Pub. No.: US 2026/0270309 A1
(43) Pub. Date: Sep. 10, 2026

(54) SELECTING VIRTUAL PRIVATE NETWORK (VPN) SERVER SERVICE FROM AMONG MULTIPLE VPN SERVERS

(71) Applicant: Connectify, Inc., Philadelphia, PA (US)

(72) Inventors: Brian Prodoehl, Plymouth Meeting, PA (US); Kevin Cunningham, Swarthmore, PA (US); Alexander Gizis, Philadelphia, PA (US)

(21) Appl. No.: 19/559,968

(22) Filed: Mar. 7, 2026

Related U.S. Application Data
(60) Provisional application No. 63/768,795, filed on Mar. 7, 2025.

(51) Int. Cl. H04L 67/1004; H04L 12/46; H04L 67/14

(52) U.S. Cl. CPC H04L 67/1004; H04L 12/4641; H04L 67/14

(57) ABSTRACT

One example may include establishing a first communication session between a client device and a first virtual private network (VPN) server and a second communication session between the client device and a second VPN server, transmitting and receiving data associated with an application over the first communication session, determining a data event has occurred based on an audit of data communications between the client device and the first VPN server, and forwarding subsequent data over the second communication session to the second VPN server.

### TECHNICAL FIELD

This application relates to data management and more particularly to managing data communications with one or more VPN servers.

### BACKGROUND

Client devices may be identified as being at a particular source and location and having specific attributes, such as a hardware device profile, an assigned IP address, an assigned network, etc. The use of client devices to perform various data access operations can be prohibited or at least limited by the settings and restrictions of the remote data sources that are being accessed by the client devices. For example, a client device may be attempting to access a secure and popular server for secure information, such as streaming content, secure order information, access to a protected account, etc.

A virtual private network (VPN) server is a service that can offer an alternative to a client device’s normal network data traffic. Generally, a VPN server may use different network routes and perform encapsulation and/or encryption among other data management operations. When client devices desire to share data and related services with other client devices, the VPN server may provide a way to connect to the Internet and remote servers to download data and forward the data to one or more requesting client devices. One or more client devices may provide data sharing with one or more other client devices by receiving the shared data through the VPN server.

Aside from the VPN server, a number of channels used by a client device at any given time may vary depending on what channels are available and the identified needs of the client device. In some cases, a client device may be simultaneously using a multitude of channels including but not limited to a Wi-Fi data channel, a cellular data channel, and a satellite data channel. The recent deployment of the STARLINK satellite network has made satellite data services more common and easier to achieve to users across the U.S. Bonding channels for optimal usage may not be limited to one data service but instead may include various different mediums and carriers being used in unison. Some of the available providers may offer more optimal download and/or upload speeds than other providers. Taking this into consideration, the strategies used to provide optimal data services may vary depending on the available resources at any given time. Additionally, individual users of client devices may prefer to utilize an alternative VPN server service depending on the types of activities being performed by the client device.

### SUMMARY

One example embodiment may include establishing a first communication session between a client device and a first virtual private network (VPN) server and a second communication session between the client device and a second VPN server, transmitting and receiving data associated with an application over the first communication session, determining a data event has occurred based on an audit of data communications between the client device and the first VPN server, and forwarding subsequent data over the second communication session to the second VPN server.

### BRIEF DESCRIPTION OF THE DRAWINGS

FIG. 1A illustrates a communication network used to support data management of client devices according to example embodiments.

FIG. 1B illustrates a communication network utilizing artificial intelligence to support data management of a client device according to example embodiments.

FIG. 2A illustrates a client device changing from a first VPN server to a second VPN server for data services based on a triggered event according to example embodiments.

FIG. 2B illustrates a client device changing from a first VPN server to a second VPN server for data services based on a specific application being used by the client device according to example embodiments.

FIG. 2C illustrates a client device changing from a first VPN server to a second VPN server for data services based on a change in a network address location according to example embodiments.

FIG. 3A illustrates an example flow diagram of an example data management process according to example embodiments.

FIG. 3B illustrates an example flow diagram of another example data management process according to example embodiments.

FIG. 3C illustrates an example flow diagram of initiating a two VPN server connection and performing a data management process according to example embodiments.

FIG. 4 illustrates a system configuration for storing and executing instructions for any of the example processes according to example embodiments.

### DETAILED DESCRIPTION

It will be readily understood that the components of the present application, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present application, the application may be applied to many types of network data, such as, packet, frame, datagram, etc. For purposes of this application, the term “message” also includes packet, frame, datagram, and any equivalents thereof. Furthermore, while certain types of messages and signaling are depicted in exemplary embodiments of the application, the application is not limited to a certain type of message, and the application is not limited to a certain type of signaling.

Example embodiments may be referred to with reference to a communication ‘session’. The term ‘session’ may be a communication data link between a ‘client’ (computing device, smartphone, computer, etc.) and ‘server’ (content server, virtual private network server, destination server, etc.) or any two or more network-based entities in communication across a data communication network. A session may be based on a single communication link or channel or multiple links or channels. Examples of multiple channels being used in a session may be based on multiple network interface devices (i.e., network interface cards (NICs)) being used in a single session, and/or multiple TCP/UDP sockets being created in a single session among other device resources. Multiple transport connections which are established via TCP and/or UDP may also be considered a session. Additionally, encryption that is used for the session may be independently established to include a unique key for each transport connection and/or channel established for the session. The session encryption may instead be a single key encryption used to encrypt all the communication exchanges during the session. In general, most transport connections are encrypted independently. All of the described examples of a session may be adapted to include one or more alternatives or combinations thereof. Each session may be subjected to multiple different communication mediums providing a variety of one or more channels, transports, radio links, physical links, network interface cards and wireless and/or wired connections.

Network connection optimization for an application server provides data network access through communication channels to one or more client devices. Data communication protocols may include one or more of a transmission control protocol (TCP) and/or a user datagram protocol (UDP). Also, the TCP/IP protocol suite enables the determination of how a specific device should be connected to the Internet and how data can be exchanged by enabling a virtual network when multiple network devices are connected. TCP/IP stands for transmission control protocol/ Internet protocol and it is specifically designed as a model to offer reliable data byte streams over various interconnected data networks.

UDP is a datagram/packet oriented protocol used for broadcast and multicast types of network transmissions. The UDP protocol may work similar to TCP, but with some of the error-checking criteria removed which reduces the amount of back-and-forth communication and deliverability requirements.

TCP is a connection-oriented protocol and UDP is a connectionless protocol. The speeds (data rates) associated with TCP are generally slower than UDP, while the speed of UDP is generally faster within the network with regard to sending data across a network. TCP uses a ‘handshake’ protocol such as ‘SYN’, ‘SYN-ACK’, ‘ACK’, etc., while UDP uses no handshake protocols. TCP performs error checking and error recovery, and UDP performs error checking, but discards erroneous packets. TCP employs acknowledgment segments, but UDP does not have any acknowledgment segment.

A TCP connection is established with a three-way handshake, which is a process of initiating and acknowledging a connection. Once the connection is established, data transfer begins and when the transmission process is finished the connection is terminated by the closing of an established virtual circuit. UDP uses a simple transmission approach without implied hand-shaking requirements for ordering, reliability, or data integrity. UDP also disregards error checking and correction efforts to avoid the overhead of such processing efforts at the network interface level, and is also compatible with packet broadcasts and multicasting.

TCP reads data as streams of bytes, and the message is transmitted to segment boundaries. UDP messages contain packets that were sent one by one. It also checks for integrity at the arrival time. TCP messages move across the Internet from one computer to another. It is not connection-based, so one program can send lots of packets to another. TCP rearranges data packets in a specific order. UDP protocol has no fixed order because all the packets are independent of each other. The speed for TCP is slower and UDP is faster since error recovery is omitted from UDP. The header sizes are 20 bytes and 8 bytes for TCP and UDP, respectively.

In general, TCP requires three packets to set up a socket connection before any user data can be sent. UDP does not require three packets for socket setup. TCP performs error checking and also error recovery and UDP performs error checking, but discards erroneous packets. TCP is reliable as it guarantees delivery of data to the destination router. The delivery of data to the destination is not guaranteed by UDP. UDP is ideal to use with multimedia such as voice over IP (VoIP) since minimizing delays is critical. TCP sockets should be used when both the client and the server independently send packets and an occasional delay is acceptable. UDP should be used if both the client and the server separately send packets, and an occasional delay is not acceptable.

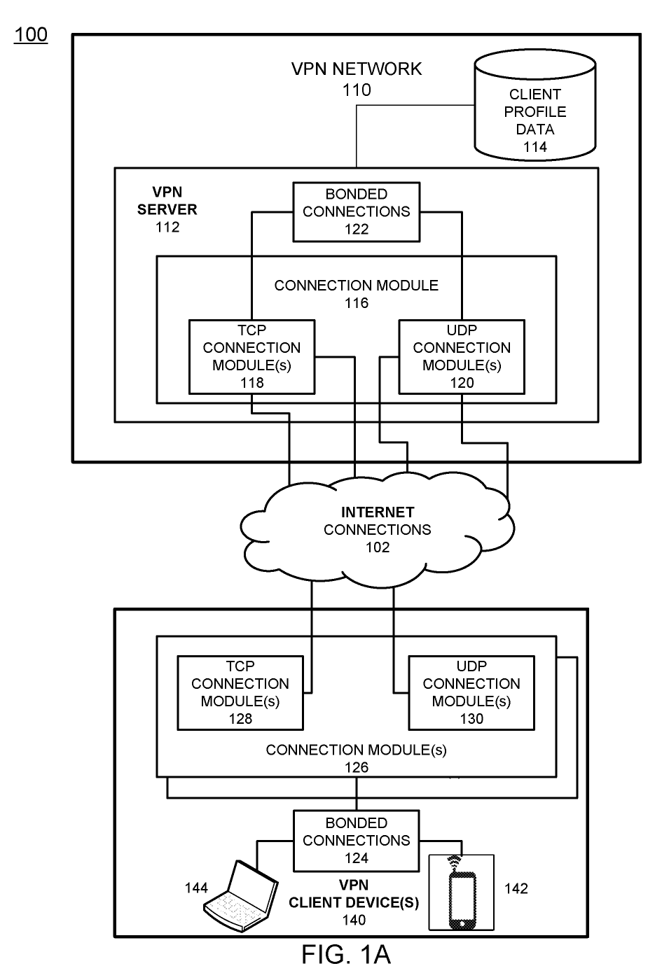

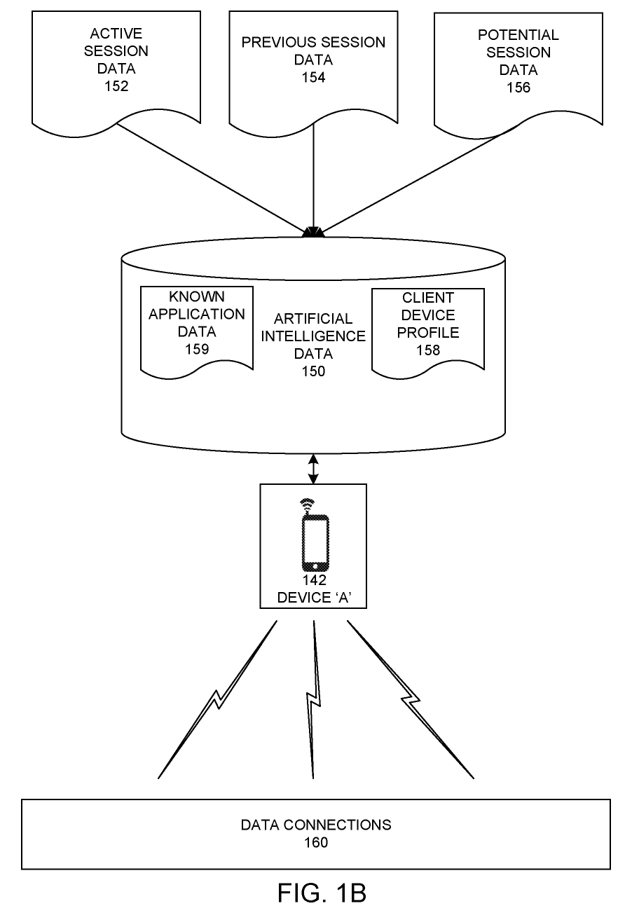

FIG. 1A illustrates an example data session network configuration according to example embodiments. Referring to FIG. 1A, the configuration 100 may include a virtual private network (VPN) 110 which includes one or more VPN servers 112 and data storage, which in this case is used for storing at least client profile data 114 associated with one or more new or old client communication sessions. The term ‘VPN’ may represent one or more servers designated to perform the VPN functionality. The communication sessions may include multiple network channels, generally, UDP and TCP are used for such sessions, however, other protocols used across the Internet 102 may also be used, such as HTTPS. The channels may be bonded together to create a single virtual channel for communication as shown from the bonded connections module 122 for the VPN server 112 and the bonded connections module 124 of the client device 140. In general, the VPN 112 may include UDP module(s) 120 and a TCP module(s) 118 as part of a connection module 116 to manage the connection process and a bonded connections module 122 to manage the various channels and the bonding of information among the channels.

The client side may include one or more client devices 140 such as a smartphone 142, cell phone, tablet, laptop 144, etc. Any one of those individual devices may be the ‘client device’ 140 at any particular time for a particular session. The client side may have an installed agent software application that communicates with the cloud servers of the VPN network 110. The communications are established and maintained across the Internet 102. The client side may also have its own bonded connections module 124 which manages one or more TCP/UDP connections associated with TCP/UDP connection modules 128/130, each of which may have multiple modules to accommodate multiple session, as part of the connection module(s) 126 of the client side. The connection module 126 may be multiple modules which are used for multiple respective sessions with various end user devices 140.

In general, a transport connection is a connection between the VPN client and the VPN server over a particular network and/or Internet connection using a particular protocol, such as TCP, UDP, HTTPS, or another protocol. The established connection is used to send encapsulated and/or encrypted application packets between the client and the server. In one example embodiment, multiple transports connections are created for each session over the available networks and protocols. Conventionally, a VPN will create one transport connection over one network with one protocol per session. For example, given two networks to utilize, the data connection optimization application may create three transport connections (e.g., TCP, UDP, and HTTPS) over each network, for a total of six transport connections. Other combinations of connection types, numbers of connections, etc., may also be utilized.

A VPN may be used by any client device participating in a collaboration session (i.e., conference) with other client devices. One device among a plurality of devices may be using a VPN while others are not using any VPN. All of the devices may send data and receive data to and from an application server in a cloud network, however, one or more client devices may use a VPN server as an intermediate/third party device to assist with the data management of that particular client device. One strategy employed by a VPN may include channel management over a single session. For example, multiple channels may exist for a single client device and can be combined into a bonded channel (unique data is sent on more than one channel), a mirrored channel (the same data is sent on more than one channel) or a combination of both. The channel management activities may permit packets to be sent and received faster and/or with fewer errors depending on the strategy employed by the VPN server. The VPN server(s) may have an optimal Internet connection to the application servers in the cloud network, and may use certain fundamental routing strategies to optimize data traffic quality, the VPN could send video data first as prioritized data from certain client devices to the cloud servers as opposed to browser request data, e-mail data, and other types of Internet data. All of these data management strategies and others can be managed by a VPN specific application that is operating on the client devices while the conference or other collaboration application is being utilized. The VPN (client) application may be a background type of application that is not detectable by the user or other applications using Internet data services. The VPN server may also attempt to host its own conference assuming the VPN server offers an application that is managed locally by the VPN server so the client devices which are part of that VPN network can have the VPN server perform additional conference application functions.

Example embodiments may include a system, a method, a device, a non-transitory computer readable medium or any combination of such configurations which provide data services to a client device, such as a mobile device, smartphone, tablet, watch, eyewear, laptop, personal computer (PC) or similar device. When a device is attempting to connect to a network for access to a network of devices, such as a local or remote network (e.g., Internet), the client device 142 may be configured to identify and connect to a number of different networks.

FIG. 1B illustrates a communication network utilizing artificial intelligence to support data management of a client device according to example embodiments. Referring to FIG. 1B, the artificial intelligence databank 150 may store data collected from a particular client’s data sessions over time. In one example, a client device 142 may be utilizing one or more data connections which are managed by the VPN server 112. Each time a data connection 160 is enabled to establish a particular channel over an ISP, a cellular communication network, a Wi-Fi network, etc., the session data may be logged to include any one or more data performance metrics, such as data rates, delay, latency, jitter, packet loss, applications used, etc. Certain application data 159 may be stored, such as which applications were used and their specific data performance metrics while being used by the client device.

Each client device may have its own profile 158 identifying connections used, applications used, performance metrics, etc. The AI databank 150 may be used by the VPN server 112 or the VPN client application installed on the device 142 to determine which data connections 160 should be used at any particular time. Over a period of time, the active session data 152 of current data sessions, previous session data 154 of past data sessions and available data sources representing potential session data 156, may be weighed to determine which of the available connections 160 should be continued, restored, activated, etc.

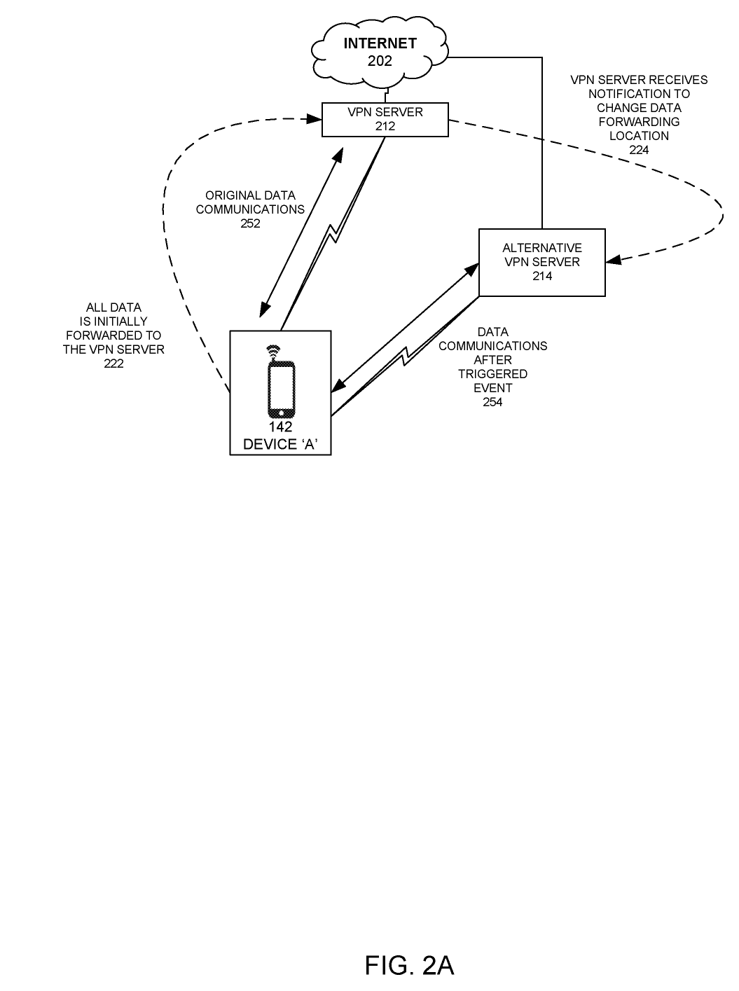

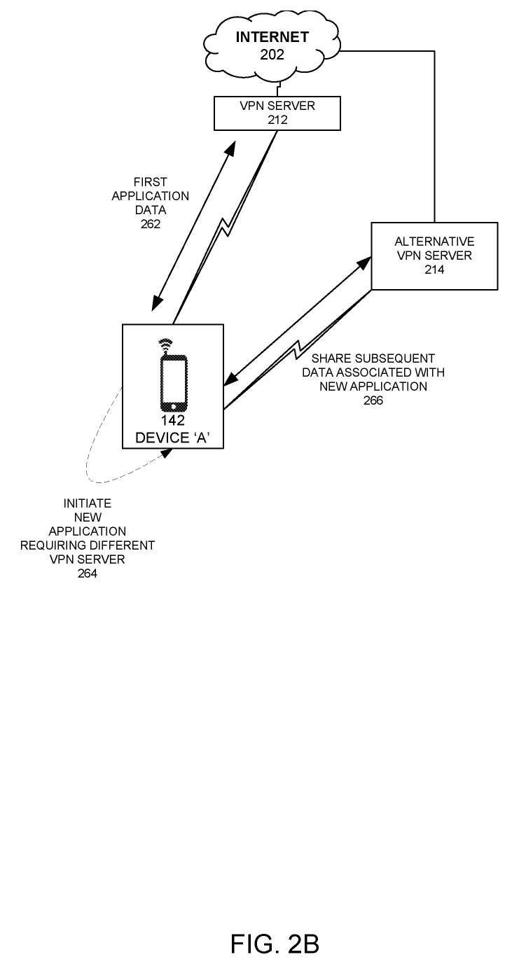

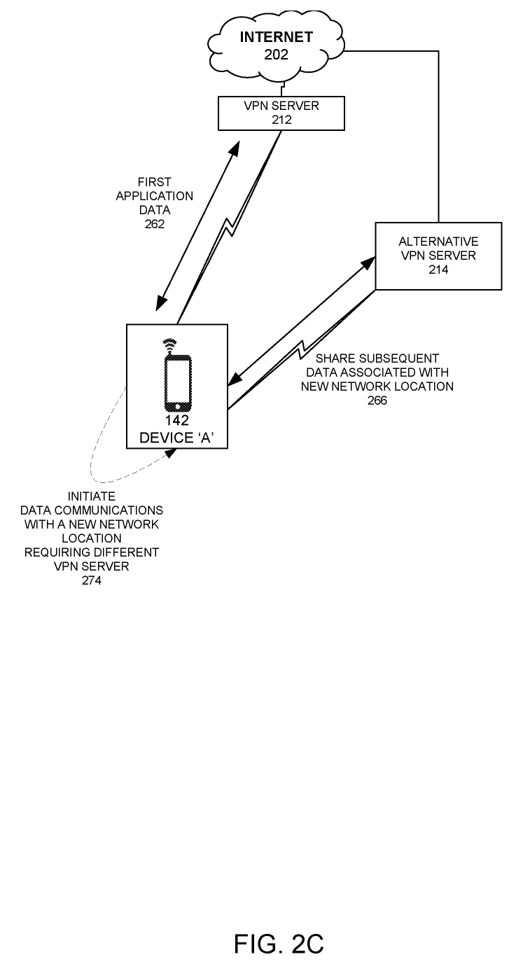

In one example, a current data session may include a cellular data channel and/or a Wi-Fi data channel that are being used to provide streaming data to the client device 142 from a remote server location. A client application used to provide optimal VPN data services to the client device may have a default VPN server service assigned to the client device 142. The artificial intelligence (AI) application data may be used by the VPN server to automatically initiate a change in which VPN server the client device 142 should be using at a particular time. Referring to FIG. 2A, an alternative VPN server 214 may be available for use depending on the circumstances associated with the data communications between the client device 142 and the VPN server 212.

In one example, the AI data 150 available to the VPN server 212 may designate a current VPN server to use for a particular data service or VPN servers which can be connected to simultaneously pending a client device use scenario outcome. In one example, there may be multiple simultaneous connections to multiple VPN servers. The decision may be made automatically to maintain a current connection until a particular event occurs which would cause an automated change in which VPN server to use for subsequent data services. An initial data use baseline may be created and stored based on a client device 142 using a particular VPN server for one or more particular applications for a particular amount of time. The baseline may be stored as a dataset in the AI data store 150. The dataset may include dataset elements including data rates experienced, latency rates, packet loss, jitter, etc. Certain known thresholds may be compared to those dataset elements to determine whether the dataset data is optimal or not optimal. Over a period of time, the VPN server 212 may determine that one or more elements of the dataset data is determined to be not optimal, which may cause a new connection to be established between the client device and another VPN server 214 in an attempt to provide the client device 142 with a new data connection and a new VPN server 214 which is likely to provide a more optimal data server. The initial VPN server used may perform the decision and switching action to occur, or, the client device may itself cause the switch to occur. All subsequent data services used by the client device 142 for that particular application may be now transmitted and received by the new VPN server 214 until a new dataset is generated and validated as being optimal or more optimal than the last dataset.

When the new dataset associated with the new VPN server 214, comprising one or more of the dataset elements including data rates experienced, latency rates, packet loss, jitter, etc., is compared to the known thresholds, and the new dataset data is identified as less optimal than the previous dataset generated with previous VPN server 212, then the new VPN server 214 may be discontinued from use and the client device 142 may revert back to the previous VPN server 212 for subsequent data usage. The AI decision making is based on baseline data over time for particular applications and for particular VPN servers. As new VPN servers become available, the options may continue to increase for assignment purposes to the client device 142. All such baseline data is stored in memory 150 and may be re-evaluated periodically to select an optimal VPN server for the client device 142.

FIG. 2A illustrates a client device changing from a first VPN server to a second VPN server for data services based on a triggered event according to example embodiments. Referring to FIG. 2A, in this example, there are more than one available VPN server including a default or initial VPN server 212 and an alternative VPN server 214. A user profile or client profile may have specific information which dictates which VPN server to use at any time. For example, an application may cause one VPN server to be used while another application may cause another VPN server to be used. As the client device 142 performs data communications with the VPN server 212 via an original or initial communication 252, one or more events, triggers or rules may be enacted to cause the change to the other VPN server 214. In one example, all data 222 is initially forwarded to the VPN server 212. A rule, or event or other criteria, when satisfied, may invoke a change from communication between the client device 142 and the VPN server 212 to the other VPN server 214. Thereafter, the communications may be exclusively sent and received between the client device 142 and the VPN server 214. The initial VPN server may identify the event necessary to trigger the change 224 to the new VPN server 214. Alternatively, the client device 142 may have its own client software that enables the criteria and decision making to be performed by the client device 142. Subsequent data may be sent to the alternative VPN server 214 after the triggered event 254. The client device 142 may establish initial connections to both VPN servers 212 and 214.

A first connection to the first VPN server 212 may be used for regular data transmitting and receiving purposes for a period of time, while the second connection to the second VPN server 214 remains dormant. Changes in the connectivity status of the original connection 252 may cause subsequent data requests and packet data to be transmitted and received on the other connection 254. In one example, a device 142 may move locations from a first location to a second location, that movement may cause a displacement that would enable the first connection to be less than optimal as compared to before the move and may also enable the second connection to be more optimal than before the move. Another cause to change connections may be the used application type changing from one application to another and the subsequent data use may be more optimal on the second VPN server connection than the first VPN server connection. Any data connection and/or client device data use triggers may cause a change from one connection and VPN to another connection and VPN. Maintaining two connections at the same time and measuring data metrics associated with the connections periodically may enable connection selection options which would otherwise not be available if the client device did not have access to multiple connection and VPN servers.

FIG. 2B illustrates a client device changing from a first VPN server to a second VPN server for data services based on a specific application being used by the client device according to example embodiments. Referring to FIG. 2B, the client device 142 may be using a VPN specific application. In this example, the first application data 262 will be sent to the VPN server 212 as originally intended. As a new application is initiated 264 by the client device 142, the subsequent data associated with the new application may be shared 266 with the alternative VPN server 214. The change in application use or initiation of the application use of an application that is assigned to a specific VPN server may cause the change in VPN server usage from the original VPN server 212 to the new VPN server 214. A local network application that is associated with the alternative VPN server 214 may cause a switch from sending data to the VPN server 212 to the different VPN server 214. One approach is to identify where data was sent previously and use that VPN server as the designated VPN server.

FIG. 2C illustrates a client device changing from a first VPN server to a second VPN server for data services based on a change in a network address location according to example embodiments. Referring to FIG. 2C, the example includes a client device 142 using a first VPN server 212 to transmit and receive first application data 262. In this example, the trigger causing a switch from one VPN server to another is the initiation of data communications at a new network location, such as a different IP address or other location criteria that is identified as being associated with the other VPN server 214. Once the new network location is identified, the subsequent data is shared 266 between the client device 142 and the new VPN server 214. The criteria may be triggered by an address filter that identifies the use of a new remote server location identified by the packet data transmitted and received by the client device 142. The alternative VPN server 214 may be pre-assigned to data being sent and received at a particular location. As the packets are identified as identifying a new location 274, the criteria matching client application associated with the client device 142 and/or the VPN server 212 may translate the data packets as requiring the alternative VPN server 214 based on a stored assignment in a data file associated with the client device communications.

One example scenario where using a first VPN server and changing to a new VPN server may include a client device using a private information data source or database. One specific instance is with private corporate information, legal information, government information, etc. In any of those cases, when a client device is using a VPN server to manage data services to and from the Internet, the attempt to communicate with one or more private networks may cause a specific VPN server to be initiated as the new VPN server to route data requests to and for such communication efforts. When a data request is identified at a current VPN server, an IP address, port, URL, etc., of the data source location may be identified by the VPN server as a non-accessible data location. The VPN server may then forward the data request to a registered alternative VPN server for that particular request. The alternative VPN server will manage all data communications with the client device for that particular data request and any subsequent data request that includes the alternative VPN server. Any ongoing sessions, streaming data sessions, other data requests may be routed by the original VPN server while the alternative VPN server manages the other data requests related to the private network and/or private data sources. A channel among multiple available communication channels may be dedicated to the alternative VPN server or all available channels may be made available to the alternative VPN server while the original VPN server may only have access to a single data channel. Any VPN server using multiple channels may bond the channels into a single logical connection for data transfers to and from the client device.

Another example may include a desktop computer at a user’s home being accessed behind a private network. When a user remotely accesses a proprietary data source via the client device, a private data source, sealed (encrypted) data files, and/or personal data files, which are accessible by a private network and not via the Internet via a standard portal, the VPN selection application operating in the VPN server and/or the client device, can switch from an assigned VPN server to a designated/alternative VPN server, by filtering an IP address, port information, network information, etc. The private network information may be on a list stored in the VPN server or client device which invokes use of the alternative VPN server.

In one example of establishing two or more VPN server connections to two or more VPN servers, a mobile user device (client device) moving in traffic and commuting from a suburban home to a downtown office may pass through areas of varying signal strength, triggering a switch from VPN server one to VPN server two when latency metrics on server two are below those of server one by a predefined threshold value, such as 20 percent less or 50 percent less, etc. Latency may be used as a basis for ongoing monitoring of client device connectivity status one both connections even though only one connection is being used at a particular time.

Another example may include a remote worker using a mobile device to transition from a video conferencing application to a large file transfer application, causing the system application to switch to the second VPN server which is optimized for high-throughput bulk data transfer rather than low-latency streaming which may be operating on the first VPN server. One approach is identifying the type of application data traffic needed and sending a pre-request message to the VPN servers to confirm such data characteristics are available on one or more of the VPN servers prior to switching from one to another. A response message may confirm the data characteristics sent in a prior packet are available. That VPN server may be the new VPN server used for data traffic purposes. Each time a new application is launched on the client device a new VPN server pre-request may be sent to all available VPN servers seeking a response and confirmation prior to using the application for data transfer purposes over one or more of the available VPN servers.

Another example may be a client device connected to a congested public Wi-Fi network at an airport detecting a rising packet loss rate on a particular VPN server through periodic metric sampling effort. The monitoring effort may be performed by the client device and/or the current VPN server being used to transfer and receive data. The client device may as a result automatically reroute data traffic to a second VPN server, which is currently utilizing a lower packet loss rate on its dormant but optionally established connection with the client device.

Another example may include a corporate client device operating a security-sensitive financial application detects that the active VPN server has a poor encryption handshake response time that is below a threshold. This may prompt an automatic failover scenario to a second VPN to maintain secure transaction integrity. A streaming media application on a user's client device may detect buffering caused by bandwidth throttling on a first VPN server and trigger a switch to another VPN server after periodic monitoring confirms consistently higher available bandwidth on the dormant connection. In one example, a healthcare worker's mobile client device may transition from sending small patient record queries to transmitting large diagnostic imaging files, and the system application may switch to the available VPN server with greater bandwidth capacity when data size metrics exceed a set threshold. In this example, the same application may be used but a change in application behavior may prompt a new VPN server usage scenario.

Additional scenarios may include a client device in a building experiences peak network congestion during business hours on a first VPN server probably because others nearby are using the same VPN server. The system application may then switch to another VPN server based on time-of-day traffic pattern analytics combined with real-time throughput comparisons between both connections at a particular time or time frame.

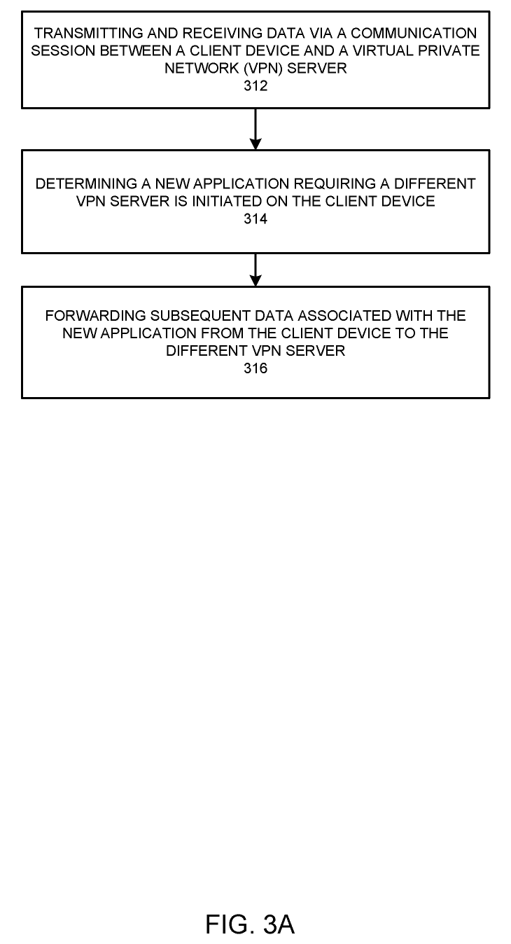

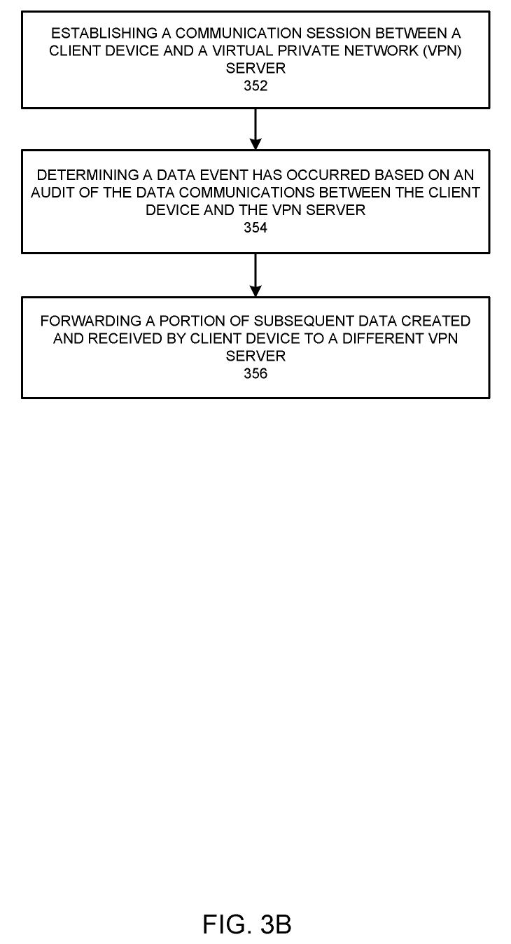

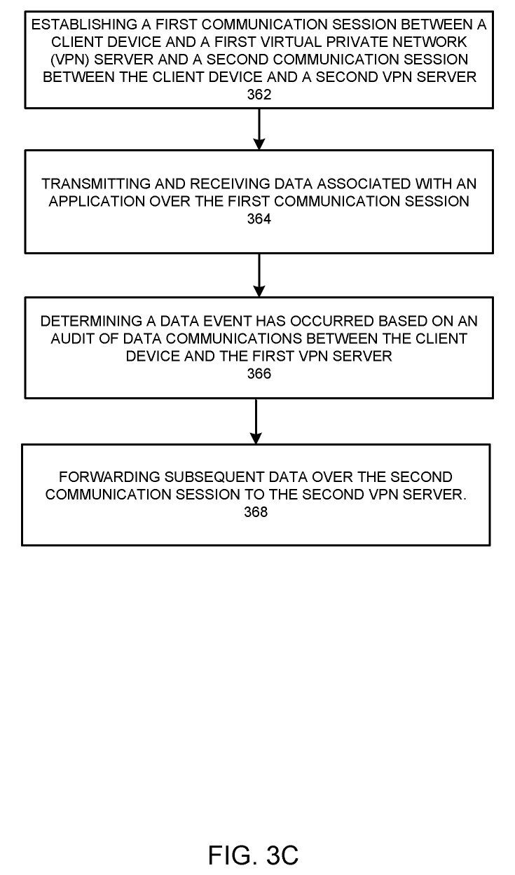

FIG. 3A illustrates an example flow diagram of an example data management process according to example embodiments. A client device, such as a mobile device, laptop or other personal use computing device may be using a VPN server for data services related to security (encryption), quality of service (jitter, data rate, latency), etc. The applications being used at a first particular time may permit all data to flow to and from the client device to a VPN server in a cloud network. A particular application may then be initiated on the client device, all subsequent data related to that application is then forwarded to a different VPN server at a different location. Ongoing data flows are bifurcated so that the first VPN server is used for data flows pertaining to previous applications. The other VPN server may be used for data pertaining to the particular applications. Automated events may include initiating the new VPN route and server upon execution of the particular application. Application use may be a trigger causing changeover to a private VPN server.

One example method of operation may include transmitting and receiving data via a communication session between a client device and a virtual private network (VPN) server 312, determining a new application requiring a different VPN server is initiated on the client device 314, and forwarding subsequent data associated with the new application from the client device to the different VPN server 316. The process may also include receiving and forwarding subsequent data associated with other applications to the VPN server. The process may also include transmitting a request to activate the different VPN server, and responsive to determining the different VPN server is active, forwarding subsequent data associated with the new application from the client device to the different VPN server.

FIG. 3B illustrates an example flow diagram of another example data management process according to example embodiments. In this example, a client device, such as a mobile device, laptop or other personal use computing device may be using a VPN server for data services related to security (encryption), quality of service (jitter, data rate, latency), a particular application, a desired data storage location, or simply an alternative route for data flow across the Internet. Different users of different client devices may have preferences for how and when their data is routed, and automated services to change from a traditional or usual VPN server to a secret or home-based VPN server may be the actionable event that causes the change. Automated events may include a particular application use by the client device, data file sizes, types of data, and location(s) of data received and/or generated.

One example method may include establishing a communication session between a client device and a virtual private network (VPN) server 352, determining a data event has occurred based on an audit of the data communications between the client device and the VPN server 354, and forwarding a portion of subsequent data created and received by client device to a different VPN server 356. The process may also include receiving and forwarding another portion of subsequent data created and received by client device to the VPN server. The data event includes identifying an application use by the client device requires the subsequent data associated with that application to be sent to the different VPN server. The data event includes identifying data usage by the client device requires the subsequent data associated with other applications to be sent to the VPN server. The process may also include transmitting a request to activate the different VPN server, and responsive to determining the different VPN server is active, forwarding the portion of the subsequent data created and received by the client device to the different VPN server.

FIG. 3C illustrates an example flow diagram of establishing multiple VPN server connections to multiple different VPN servers. Referring to FIG. 3C, the method may include establishing a first communication session between a client device and a first virtual private network (VPN) server and a second communication session between the client device and a second VPN server 362, transmitting and receiving data associated with an application over the first communication session 364, determining a data event has occurred based on an audit of data communications between the client device and the first VPN server 366 and forwarding subsequent data over the second communication session to the second VPN server 368.

The process may also include receiving and forwarding another portion of the subsequent data created and received by the client device to the VPN server after a period of time. This may include a different application than the application being used to create, transmit and receive data used by the other application which is utilizing the second VPN server. A client device may have multiple VPN servers being utilize for multiple different applications being used concurrently on the client device. The reason for one VPN server assisting with the one application may be based on data metric values provided by that particular VPN server. If the metric values are sufficient for the data transmission and reception needs of the data application then the VPN server may be used. When a VPN server cannot provide the necessary metric values and the connection is identified as having elevated latency and packet loss as compared to known acceptable levels, then the other VPN server(s) available may be invoked for use with that particular application.

In another example, the data event may include identifying the application used by the client device requires the subsequent data associated with the application to be sent to the different VPN server because the first VPN server is not providing sufficient data metric values. The data event may include identifying data usage by the client device requires the subsequent data associated with other applications being used by the client device to be sent to the VPN server. The method may also include transmitting a request to the second VPN server to initiate a data exchange, and responsive to receiving a response from the second VPN server, forwarding the subsequent data from the client device to the second VPN server. Even though the second VPN server connection is established, the attempt to transmit and receive data via the second VPN server may require a pre-authorization or pre-request message be confirmed by the VPN server prior to transmitting and receiving data.

The audit may include a periodic analysis that measures data metric values on the first communication session. The process may also include determining one or more data metric values is outside of a supported range of data metric values associated with the application, measuring data metric values on the second communication session, and determining the second communication session is a more optimal connection for the application than the first communication session.

In one example, the client device may connect first to a first VPN server (VPN1), then to a second or more VPN servers. There may be multiple VPN servers which are connected to one client device at one particular time. The number of VPN servers and respective connections to a single client device operating a VPN application may be 1, 2, 3, 4 or even ‘N’ as an integer between 1 and 100. In this example, we will use two VPN servers and connections. The second VPN server (VPN2) may be a dormant connection that is not being used to transmit and receive data on a regular basis, however, a minimal number of packets may be sent and received by the client device over the dormant connection to maintain connectivity. In one example, the client device may use VPN1 for a particular application, such as a web browser or data streaming, etc. The client device may then seek to initiate a second application that operates concurrently during operation of the first application. When the second application initiates, an AI or machine learning model may be trained to detect the data metrics necessary to operate the second application and the first application based on previous use by the applications stored in memory. Also, the purpose of the applications may be considered for how much data is necessary at any given time along with packet loss tolerance, jitter, latency and bandwidth requirements and other data metrics may be contemplated. The trained model may use historical application use data measured over time to determine that VPN1 will not be able to support the data metric needs of the second application, especially when the first application is still in use or could be in use. The concatenation of data needs for all active applications may cause a change in VPN selection and use for a period of time. When a deficiency in future use is detected and predicted by the trained model, the VPN application on the client device may initiate use of the VPN2 connection for all the data associated with the second application. Initially, the first application may only use the first VPN1 and the second application may only use the second VPN2 for data transmission and reception. However, both connections may be used for one application and one connection may be used for the other application.

When having multiple VPN connections active for a single client device using a VPN client application service, the failure of one VPN may be instantly rectified by a failover service that relies on the second VPN server. When a client device is traveling a short distance, the primary VPN connection may not be at issue due to similar Wi-Fi and cellular data services. However, when a user moves a client device a larger distance, proximity may become a concern for a particular VPN server as there may be another VPN server at a location that is closer to the client device at a later time. One approach during a long distance traveling event may be to establish multiple VPN connections and seek to transmit and receive data at a VPN device that is closest to the client device at a particular time.

An example of tiered network use with multiple VPN servers may include a remote work location using satellite data, such as a vessel at sea or other limited data capacity scenario, which may have a corporate senior priority network, a lesser staff priority network and/or a third network for paying customers that is somewhere in-between the other two networks in terms of data services, reliability and overall network access options. The user accounts may dictate which VPN server is selected for a particular data service based on rights and privileges assigned to each account in a table or other data recordation format. A privileged user may have access to one VPN server service and a non-privileged user may have access to another VPN server service that is less promising and which lacks the same data metric guarantees of the other VPN server.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

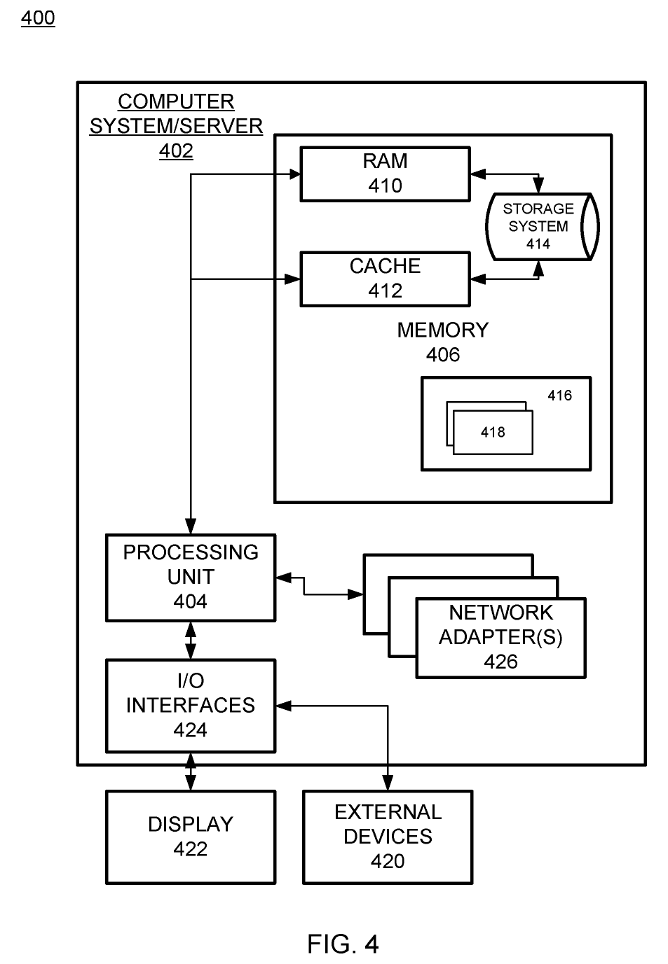

FIG. 4 illustrates an example network entity device configured to store instructions, software, and corresponding hardware for executing the same according to example embodiments. FIG. 4 is not intended to suggest any limitation as to the scope of use or functionality of embodiments of the application described herein. Regardless, the computing node 400 is capable of being implemented and/or performing any of the functionality set forth hereinabove.

In computing node 400 there is a computer system/server 402, which is operational with numerous other general purpose or special purpose computing system environments or configurations. Examples of well-known computing systems, environments, and/or configurations that may be suitable for use with computer system/server 402 include, but are not limited to, personal computer systems, server computer systems, thin clients, rich clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 402 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 402 may be practiced in distributed cloud computing environments where tasks are performed by remote processing devices that are linked through a communications network. In a distributed cloud computing environment, program modules may be located in both local and remote computer system storage media including memory storage devices.

As displayed in FIG. 4, computer system/server 402 in cloud computing node 400 is displayed in the form of a general-purpose computing device. The components of computer system/server 402 may include, but are not limited to, one or more processors or processing units 404, a system memory 406, and a bus that couples various system components including system memory 406 to processor 404.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 402 typically includes a variety of computer system readable media. Such media may be any available media that is accessible by computer system/server 402, and it includes both volatile and non-volatile media, removable and non-removable media. System memory 406, in one embodiment, implements the flow diagrams of the other figures. The system memory 406 can include computer system readable media in the form of volatile memory, such as random-access memory (RAM) 410 and/or cache memory 412. Computer system/server 402 may further include other removable/non-removable, volatile/non-volatile computer system storage media. By way of example only, storage system 414 can be provided for reading from and writing to a non-removable, non-volatile magnetic media (not displayed and typically called a “hard drive”). Although not displayed, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 406 may include at least one program product having a set (e.g., at least one) of program modules that are configured to carry out the functions of various embodiments of the application.

Program/utility 416, having a set (at least one) of program modules 418, may be stored in memory 406 by way of example, and not limitation, as well as an operating system, one or more application programs, other program modules, and program data. Each of the operating system, one or more application programs, other program modules, and program data or some combination thereof, may include an implementation of a networking environment. Program modules 418 generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 402 may also communicate with one or more external devices 420 such as a keyboard, a pointing device, a display 422, etc.; one or more devices that enable a user to interact with computer system/server 402; and/or any devices (e.g., network card, modem, etc.) that enable computer system/server 402 to communicate with one or more other computing devices. Such communication can occur via I/O interfaces 424. Still yet, computer system/server 402 can communicate with one or more networks such as a local area network (LAN), a general wide area network (WAN), and/or a public network (e.g., the Internet) via network adapter(s) 426. As depicted, network adapter(s) 426 communicates with the other components of computer system/server 402 via a bus. It should be understood that although not displayed, other hardware and/or software components could be used in conjunction with computer system/server 402. Examples include, but are not limited to: microcode, device drivers, redundant processing units, external disk drive arrays, RAID systems, tape drives, and data archival storage systems, etc.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method comprising
establishing a first communication session between a client device and a first virtual private network (VPN) server and a second communication session between the client device and a second VPN server;
transmitting and receiving data associated with an application over the first communication session;
determining a data event has occurred based on an audit of data communications between the client device and the first VPN server; and
forwarding subsequent data over the second communication session to the second VPN server.

2. The method of claim 1, comprising
receiving and forwarding another portion of the subsequent data created and received by client device to the VPN server after a period of time.

3. The method of claim 1, wherein the data event comprises identifying the application used by the client device requires the subsequent data associated with the application to be sent to the different VPN server.

4. The method of claim 1, wherein the data event comprises identifying data usage by the client device requires the subsequent data associated with other applications being used by the client device to be sent to the VPN server.

5. The method of claim 1, comprising
transmitting a request to the second VPN server to initiate a data exchange; and
responsive to receiving a response from the second VPN server, forwarding the subsequent data from the client device to the second VPN server.

6. The method of claim 1, wherein the audit comprises a periodic analysis that measures data metric values on the first communication session.

7. The method of claim 6, comprising
determining one or more data metric values is outside of a supported range of data metric values associated with the application;
measuring data metric values on the second communication session; and
determining the second communication session is a more optimal connection for the application than the first communication session.

8. An apparatus comprising
a processor configured to establish a first communication session between a client device and a first virtual private network (VPN) server and a second communication session between the client device and a second VPN server; and
a transmitter configured to transmit and receive data associated with an application over the first communication session;
wherein the processor is further configured to
determine a data event has occurred based on an audit of data communications between the client device and the first VPN server; and
forward subsequent data over the second communication session to the second VPN server.

9. The apparatus of claim 8, wherein the processor is further configured to
receive and forward another portion of the subsequent data created and received by client device to the VPN server after a period of time.

10. The apparatus of claim 8, wherein the data event comprises identifying the application used by the client device requires the subsequent data associated with the application to be sent to the different VPN server.

11. The apparatus of claim 8, wherein the data event comprises identifying data usage by the client device requires the subsequent data associated with other applications being used by the client device to be sent to the VPN server.

12. The apparatus of claim 8, wherein the processor is further configured to
transmit a request to the second VPN server to initiate a data exchange; and
responsive to receiving a response from the second VPN server, forward the subsequent data from the client device to the second VPN server.

13. The apparatus of claim 8, wherein the audit comprises a periodic analysis that measures data metric values on the first communication session.

14. The apparatus of claim 13, wherein the processor is further configured to
determine one or more data metric values is outside of a supported range of data metric values associated with the application;
measure data metric values on the second communication session; and
determine the second communication session is a more optimal connection for the application than the first communication session.

15. A non-transitory computer readable storage medium configured to store instructions that when executed cause a processor to perform:
establishing a first communication session between a client device and a first virtual private network (VPN) server and a second communication session between the client device and a second VPN server;
transmitting and receiving data associated with an application over the first communication session;
determining a data event has occurred based on an audit of data communications between the client device and the first VPN server; and
forwarding subsequent data over the second communication session to the second VPN server.

16. The non-transitory computer readable storage medium of claim 15, wherein the processor is further configured to perform:
receiving and forwarding another portion of the subsequent data created and received by client device to the VPN server after a period of time.

17. The non-transitory computer readable storage medium of claim 15, wherein the data event comprises identifying the application used by the client device requires the subsequent data associated with the application to be sent to the different VPN server.

18. The non-transitory computer readable storage medium of claim 15, wherein the data event comprises identifying data usage by the client device requires the subsequent data associated with other applications being used by the client device to be sent to the VPN server.

19. The non-transitory computer readable storage medium of claim 15, wherein the processor is further configured to perform:
transmitting a request to the second VPN server to initiate a data exchange; and
responsive to receiving a response from the second VPN server, forwarding the subsequent data from the client device to the second VPN server.

20. The non-transitory computer readable storage medium of claim 15, wherein the audit comprises a periodic analysis that measures data metric values on the first communication session.
